(19) United States
(12) Patent Application Publication
(10) Pub. No.: US 2026/0133816 A1
(43) Pub. Date: May 14, 2026

(54) PRESERVING CACHE DATA IN A LIVE UPDATE SCENARIO

(71) Applicant: INTERNATIONAL BUSINESS MACHINES CORPORATION, Armonk, NY (US)

(72) Inventors: Ravikishore Krishnamurthy, Bangalore (IN); Shivarudrappa Satyanaik, Bengaluru (IN); Veeresh Jumanal, Bangalore (IN); Rizwan Sheikh Abdulla, Bangalore (IN); Sivaprakasam Sivasubramanian, Bengaluru (IN)

(21) Appl. No.: 18/941,186

(22) Filed: Nov. 8, 2024

(51) Int. Cl. G06F 9/455; G06F 8/656

(52) U.S. Cl. CPC G06F 9/45558; G06F 8/656; G06F 2009/4557; G06F 2009/45583

(57) ABSTRACT

Cache data preservation includes identifying, as setup for migrating a running workload from an initial virtual machine executing on a host system to an update virtual machine executing on the host system as part of a live update, cache data of the initial virtual machine, where at least some of the cache data is used in processing the running workload, mirroring the cache data to persistent memory, and based on performance of live update processing that includes creating the update virtual machine and providing the update virtual machine with an operating system updated relative to an operating system of the initial virtual machine, mirroring the cache data from the persistent memory to the update virtual machine. Based on completion of the live update processing, the update virtual machine takes over processing of the running workload and includes the mirrored cache data.

### BACKGROUND

Aspects relate to effective delivery of high-availability computing environments, and more specifically to minimizing downtime and performance degradation in live update scenarios. In a high-availability computing environment, such as a hybrid cloud environment that processes workloads, downtime and performance degradation is highly undesirable.

### SUMMARY

Shortcomings of the prior art are overcome and additional advantages are provided through the provision of a computer-implemented method. The method includes identifying, as setup for migrating a running workload from an initial virtual machine executing on a host system to an update virtual machine executing on the host system as part of a live update, cache data of the initial virtual machine. At least some of the cache data is used in processing the running workload. The method also includes mirroring the cache data to persistent memory. The method further includes, based on performance of live update processing that includes creating the update virtual machine and providing the update virtual machine with an operating system updated relative to an operating system of the initial virtual machine, mirroring the cache data from the persistent memory to the update virtual machine. Based on completion of the live update processing, the update virtual machine takes over processing of the running workload and includes the mirrored cache data.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example graphical representation of an existing live update operation;

FIG. 3 depicts an example workflow for cache data preservation, in accordance with aspects described herein,

FIGS. 4A-4D depict example conceptual diagrams of phases of the workflow of FIG. 3, in accordance with aspects described herein;

FIG. 5 depicts further details of an example cache data preserving code to incorporate and/or use aspects described herein; and

FIG. 6 depicts an example process for preserving cache data, in accordance with aspects described herein.

### DETAILED DESCRIPTION

Described herein are approaches for minimizing downtime and performance degradation in live update scenarios, and specifically for preserving cache data across live update processing that migrates a running workload from one machine to an updated machine. Tenants in hybrid cloud environments running business-critical workloads expect minimal workload downtime. Downtime can often be associated with the deployment of patches/updates, for instance updates to a kernel of the operating system of a virtual machine or other system running the workload, updates to kernel extensions, or updates to libraries, as examples. Some such updates might require a virtual machine reboot to take effect. However, it is desirable that such patches/updates take effect with no downtime to the running workloads and that subsequent processing of the workloads can take advantage of the applied updates. Yet another expectation in business-critical environments is high performance, as it is desirable that the performance of the system running the workload does not deteriorate regardless of the operations performed in the environment. In some situations, performance can be bolstered by leveraging flash caching (also referred to as server-side caching) of data, which enables a virtual machine to use solid-state drives or flash storage to improve performance relative to spinning disks or other, slower, storage. The flash cache can be directly attached to the host system, or provided across a network, for instance from a storage area network as an example.

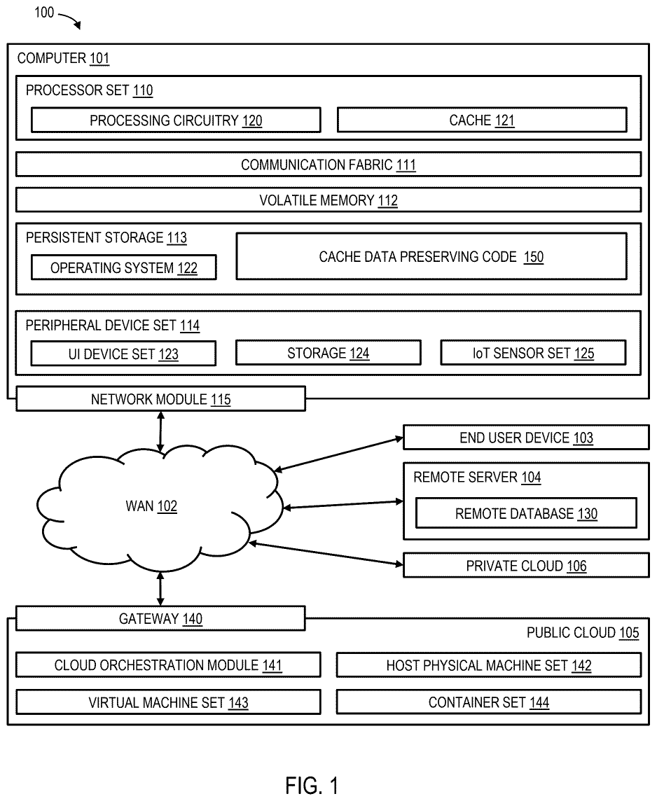

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as cache data preserving code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, it is noted that advantages described or set-forth explicitly or implicitly herein may not be present in all embodiments described herein, and are not necessarily required of all embodiments described herein.

Live update (LU) technology exists for non-disruptive operating system updating. Under the live update approach, a running workload can be sustained in terms of continued processing without stoppage despite operating system updates being applied. In a specific example, when a kernel fix or other update is available and is to be applied, a live update provides the ability to implement the update without having to stop the running workload (i.e. without downtime) and wait for the update to be applied and the system executing the workload (for instance the virtual machine hosting the workload) to be rebooted. More specifically, an initial virtual machine (which may be referred to as an original virtual machine) of a host system processes a running workload, and, based on existence of an update to be applied, and orchestrator, such as a hypervisor of the host system, or another component, creates on the host system another virtual machine (referred to herein as an update virtual machine or surrogate virtual machine) that has the same or similar characteristics as an initial virtual machine. The update is applied to the update virtual machine, and then the running workload is migrated to the update virtual machine to takeover the processing of that workload. Often the update virtual machine will be a new virtual machine created with equivalent (or greater) memory, processing (e.g. CPU), input/output (I/O), and storage resources as those of the initial virtual machine, but will have the update applied. In some examples, a root volume group or other storage of the update virtual machine (surr-boot-rootvg) will be a cloned image of the root volume group (orig-rootvg) of the initial virtual machine but with the update applied. After the update virtual machine is booted with the update applied, the running workload is migrated from the initial virtual machine to the update virtual machine. The update virtual machine takes over and the initial virtual machine can be deleted, repurposed, etc.

Under existing live update approaches, cached data—data that is cached for the initial virtual machine—is lost after the live update process concludes. Since the cache data is lost during this operation, this can result in significant negative performance impact to the applications being run as part of the running workload. Existing live update methods for virtual machines running in the cloud environments fail to retain the cache data of the initial virtual machine and put it back into use, thus resulting in performance degradation. Since the cache data is lost, the update virtual machine must build back (populate) its cache from scratch, which is undesirable.

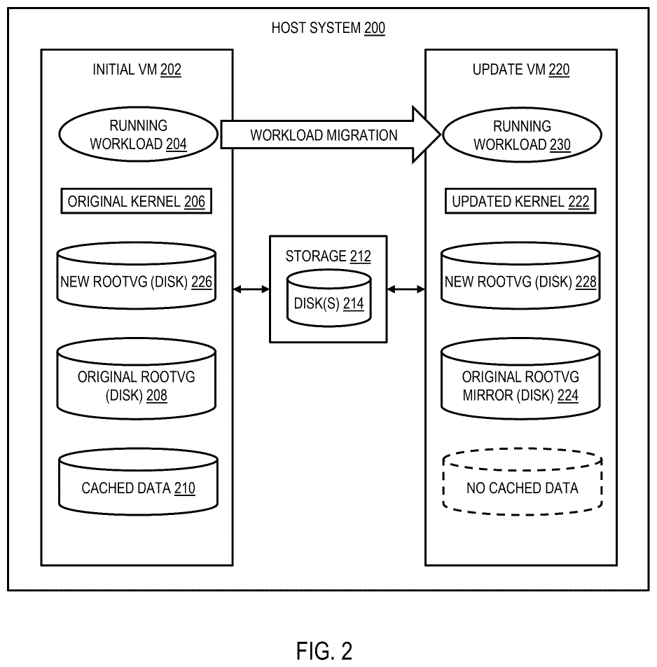

By way of example for illustration, FIG. 2 depicts an example graphical representation of a live update operation discussed above. Host system 200 includes an initial/original virtual machine 202 supporting a running workload 204. For instance, the virtual machine 202 processes the workload 204 using processing resources (not depicted). The initial virtual machine 202 executes an operating system having an original kernel 206, which is to say an ‘initial’ kernel of one version that is different than an updated version of the kernel. The initial virtual machine 202 also has an original root volume group 208 (original rootvg) as disks for storage, for instance to store the operating system and other data of the virtual machine. Typically the rootvg is backed by storage in the form of hard disk drives (hdisks), which could be part of host system 200 or could be network-provided, for instance from a storage area network (SAN) as part of an environment in which is host is installed. Further, as part of the virtual machine's execution, including to run the workload, data caching occurs to build a cache of data 210. The device(s) used for cache storage are typically fast memory device such as nonvolatile memory express (NVMe) and/or dynamic random access memory (DRAM) devices.

Host system 200 also includes update virtual machine 220. The update virtual machine could be instantiated by the host system. Additionally or alternatively, a hardware management console (HMC) (not pictured) could be provided that is responsible for maintaining the various systems of the computing environment, creating the virtual machines, and other activity, while the hypervisor is primarily responsible for managing resources of the host system. Many variations are possible.

In any case, in this example a kernel update has been issued for the original kernel 206. The update virtual machine 220 is instantiated with, or is subsequently updated to install thereon, the updated kernel 222. The update virtual machine 220 also has the original rootvg (208) mirrored thereon as original rootvg mirror 224. Further, a new root volume group is created and provided on both the initial virtual machine (as 226) and the update virtual machine (as 228), which will be the new root volume group post-update. In this example, storage 212 provided as part of, or made accessible to, the host system includes disks(s) 214 for storage of the virtual machine data, for instance as backing storage for the volume groups 208, 226, 224, and 228, and any other data to be stored.

With the updated kernel on the update virtual machine, the live update processing can migrate the running workload 204 from initial virtual machine 202 to update virtual machine 220 as workload 230, and keep the workload running. This form of live updating may be effective for avoiding downtime, but cache data 210 is not migrated to the update virtual machine. Deletion of the initial virtual machine, which is a common action after the live update has occurred and the workload has been migrated, deletes the cache data 210. This can result in significant performance degradation in the workload processing on the update virtual machine relative to workload processing on the initial virtual machine on account that needed data is accessible in cache storage to the update virtual machine; it therefore must be retrieved from disk (e.g., of storage 212), which is generally a much slower action than retrieval from cache storage.

Thus, in accordance with aspects described herein, a technical solution is provided to retain the cached data of an initial virtual machine during and after the live update processing to migrate a running workload. The cache data can be provided to the update virtual machine for the update virtual machine to utilize in continuing the uninterrupted processing of that running workload.

In examples, the cache data is mirrored to persistent memory for retention during the live update. The persistent memory could include virtual persistent memory (vPMEM). vPMEM is a virtualization feature that presents a portion of installed system memory, for instance dynamic random access memory (DRAM) provided by memory module(s), such as dual in-line memory module (DIMMs), as non-volatile devices to the operating system. The ‘virtual’ qualifier denotes that this differs from true persistent memory, since system DRAM is volatile memory rather than non-volatile memory. The persistent memory could optionally include other storage, for instance network-provided disk-based (non-volatile) storage or other storage, as supplemental storage to hold some cache data, for instance if an allocated amount of VPMEM is not sufficient to retain all desired cache data of the initial virtual machine.

In a specific embodiment, a hypervisor, vPMEM, and optionally supplemental storage, are leveraged to retain cache data and make it available to the update virtual machine. The cache data that has been retained and made available can be used by the update virtual machine after the live update processing is completed.

In some examples, the hypervisor performs processing as setup for migrating a running workload from the initial virtual machine to the update virtual machine as part of a live update. For instance, the hypervisor checks the initial virtual machine for the presence of cache data before the live update operation and fetches relevant details of the cache data. Example details could include the size of the cache data and information about the various data in cache data, for instance which data is hot and which data is cold. In this regard, the ‘warmth’ of cache data can refer to the frequency of the data's access/use, the recency with which the data was placed into or updated in the cache, the importance of the data to the executing module(s) of the system, whether the data is stale, and/or other properties of the data or its use. In general, the warmer a portion of cached data is, the greater or more likely the (negative) impact will be to the system if that data is no longer available in the cache.

Cache data warmth can be used to prioritize the mirroring of the cache data to the persistent memory. For instance, it might be desired to prioritize mirroring the most frequently used cache data to allocated vPMEM and the least frequently used cache data to the supplemental storage, particularly when the allocated amount of vPMEM is insufficient to house all of the cache data to be mirrored. In accordance with some aspects, cache data can be separated based on cache data warmth into two (or more) groups corresponding to the two (or more) persistent storage devices available. Cached data that is accessed relatively frequently by applications, and is thus important to retain for fastest retrieval, may be tagged as ‘hot’, while the rest of the data—data used relatively infrequently in comparison—may be tagged as ‘cold’. Optionally, if an amount of vPMEM being allocated for the mirroring is known at this point, then that amount of cache data can be tagged for mirroring to the vPMEM, and the selection of which specific cache data to mirror can prioritize selection of the hottest cache data (the data can be selected from hottest to coldest to fill the vPMEM).

With the cache data identified, vPMEM can be allocated/assigned to the initial virtual machine. In this regard, there may be a dynamic allocation of the vPMEM for the purpose of housing the cache data to be mirrored from the initial virtual machine. The amount of vPMEM allocated/assigned can be based on any relevant factors. It could be determined as a function of the amount of cache data identified. For instance, if enough vPMEM can be allocated to house all of the cache data desired to be mirrored, then this amount could be allocated. If there is insufficient vPMEM available to house the full amount the cache data to be retained, then any desired percentage (90%, 80%, etc.) of that amount could be allocated. In any case, the process could dynamically assign the vPMEM to the initial virtual machine based on identifying the cache data, and then mirror at least some of the cache data to the vPMEM. Any cache data that is to be retained but that is not mirrored to vPMEM could instead be mirrored to supplemental storage.

With the cache data mirrored, the live update processing can commence/proceed. At some later point in time, the cache data that was mirrored to the persistent memory (e.g., vPMEM and optional supplemental storage) is mirrored into the update virtual machine. In examples, live update processing proceeds according to known practices to a cutover point at which the live update is to complete and the update virtual machine is to fully takeover the handling of the running workload. At that point, the cache data can be mirrored into the update virtual machine. In other examples, the cache data may be mirrored before or after that cutover point. In any case, based on completion of the live update processing, which includes migration of the running workload, the update virtual machine takes over processing of the running workload and has the cache data to use in this processing. Thus, when this approach is implemented, cache data will be retained and can be utilized by the update virtual machine, thereby maintaining the performance of the system and preserving the cache data for seamless use by the update virtual machine. In this regard, cache data that is in the update virtual machine and is readily available for use from its cache may have been previously cached by another virtual machine (the initial virtual machine), such that the update virtual machine did not undertake the process of caching the data based on data access requests that it handled, but rather the data was cached by a different virtual machine pursuant to request(s) that that virtual machine previously handled.

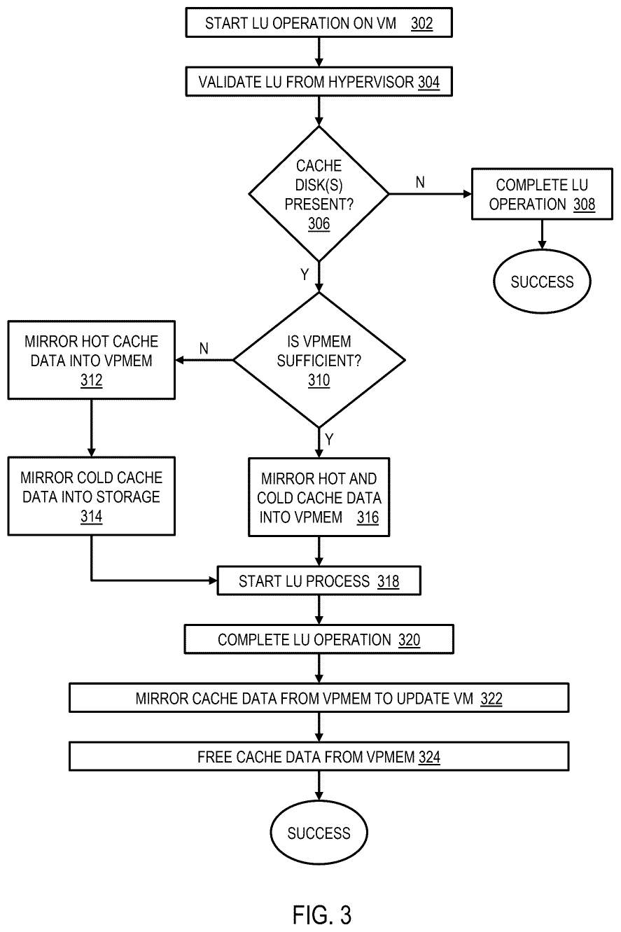

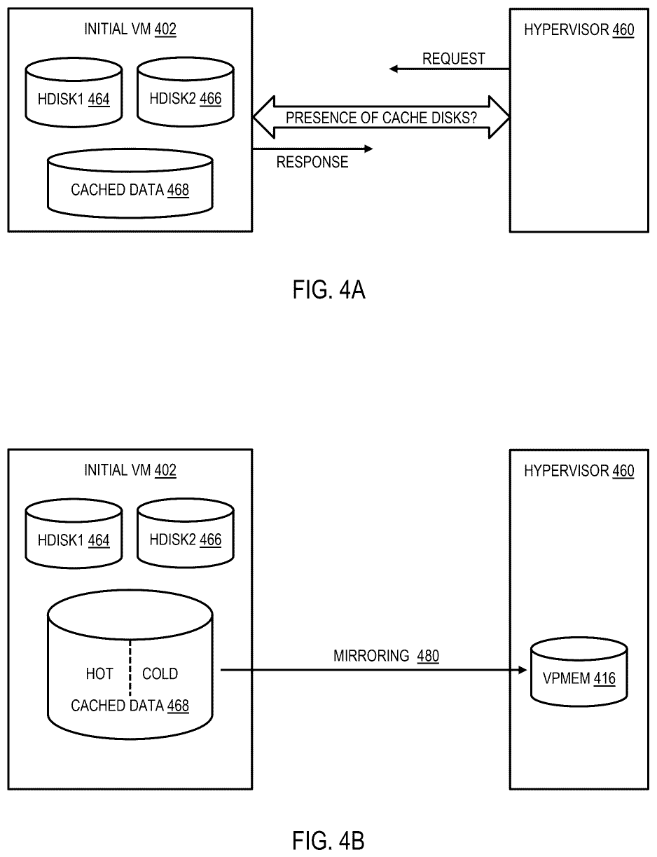

Aspects are further described with reference to FIG. 3, depicting an example workflow for cache data preservation in accordance with aspects described herein, and FIGS. 4A-4D depicting example conceptual diagrams of phases of the workflow of FIG. 3, in accordance with aspects described herein. In some examples, aspects of the workflow of FIG. 3 are performed in whole or in part by the hypervisor of the host system, which can optionally also be what performs live update processing to perform the live update.

Referring initially to FIG. 3, the live update operation is started (302) on the initial virtual machine. Based on this, the host hypervisor performs a live update validation (304) to validate the live update. During this live update validation processing, the initial virtual machine communicates with the hypervisor to validate the required resources and cache data availability. This is conceptually depicted in FIG. 4A, showing original virtual machine 402 having hdisk1 464, hdisk1 466, and cache data 468, and hypervisor 460. The hypervisor 460 sends a request to the original virtual machine 402 inquiring about the presence of cache disks/data to preserve. The original virtual machine 402 responds to the hypervisor 460 informing whether cache data for preservation is present.

Referring back to FIG. 3, the workflow determines (306) whether cached disk(s) (i.e., cache data) are present. If not (306, N), then the live update operation/processing completes per standard practice (308), and the workflow ends in a successful live update. If instead it is determined at 306 that cached disk(s) are present (306, Y), then the hypervisor initiates a next phase. In this manner, the processing identifies, as setup for migrating the running workload from the initial virtual machine to the update virtual machine as part of a live update, cache data of the initial virtual machine. In addition, the hypervisor could assess at this point the warmth of the various cached data. Additionally, vPMEM can be dynamically assigned to the initial virtual machine based on having identified the cache data. The vPMEM might or might not be sufficient to house all of the cache data to mirror. The workflow therefore proceeds by determining (310) whether the assigned amount of vPMEM is sufficient. The mirroring of the cache data can commence based on this determination. In this example, there is a delineation between hot and cold cache data, and the vPMEM assigned is at least large enough to house the hot cache data, if not also the cold cache data. If it is determined at 310 that the assigned vPMEM is not sufficient for both (310, N), then the workflow proceeds by mirroring (312) the hot cache data into vPMEM, then mirroring (314) the cold cache data into the supplemental storage. If instead it is determined at 310 that the assigned vPMEM is sufficient for both (310, Y), then the workflow proceeds by mirroring (316) the hot and cold cache data into vPMEM. This latter scenario in the context of FIG. 4A is conceptually depicted in FIG. 4B, showing a delineation of the cache data between hot and cold cache data, and the mirroring 480 mirroring the cache data into vPMEM (shown within the context of the hypervisor here).

By way of a specific example, based on the hypervisor detecting cached data in the initial virtual machine, the hypervisor will start mirroring the initial virtual machine's cache data to vPMEM. If there is an insufficient amount of vPMEM, the hypervisor determines to mirror only the hot cache data into the vPMEM and mirror the cold cache data into supplemental storage available to the initial virtual machine. In another embodiment, the hypervisor mirrors cache data into the cache based on cache data warmth, i.e., mirroring the cache data in order from hottest to coldest until the vPMEM has been filled, at which point the hypervisor directs the rest of the cache data being mirrored to supplemental storage. In some examples, warmth of cache data is based solely or partially on frequency of use of the cache data, but other properties or characteristics are possible. In any case, the hypervisor mirrors the cache data to persistent memory, which includes at least virtual persistent memory. The virtual persistent memory is backed by dynamic random access memory, for instance. In some examples, the persistent memory further includes supplemental storage to supplement the dynamically assigned virtual persistent memory, where the mirroring of the cache data mirrors a portion of the cache data to the virtual persistent memory, with that portion potentially consuming the virtual persistent memory assigned to the initial virtual machine, and mirrors a remaining portion of the cache data to the supplemental storage.

Referring back to FIG. 3, with the cache data mirrored by way of 316 or by way of the combination of 312 and 314, the workflow starts (318) live update processing and completes (320) live update operation(s). This is conceptually depicted in FIG. 4C. Live update processing is initiated on the update virtual machine 420, followed by a cleanup process on the original virtual machine 402, during which the original virtual machine's cached disks and processing, memory, and network resources are freed back to the host system. The original virtual machine 402 can be deleted, and the update virtual machine 420 can assume the identity of the original virtual machine 402, for instance it can be renamed to that of the former original virtual machine 402 to thereby become an ‘original’ virtual machine involved in a subsequent live update if needed.

The other components in FIG. 4C, including host system (400), running workload 404 and 430 (with running workload 404 being migrated 438 from initial virtual machine 402 to update virtual machine 420 as running workload 430), original kernel 406, updated kernel 422, rootvgs 426 and 408 of the original virtual machine 402, rootvgs 428 and 424 of the update virtual machine 420, and storage 412 with disk(s) 414, are as described above with reference to FIG. 2. In connection with the live update processing to perform the live update, the live update can proceed as discussed with reference to FIG. 2 in an effort to migrate the running workload.

Unlike the conventional scenario where the cache data is unavailable/lost, based on performance of live update processing that includes creating the update virtual machine and providing the update virtual machine with the updates (e.g., the updated kernel here), the hypervisor can mirror the cache data from the persistent memory to the update virtual machine. In some examples, once the live update operation is completed, or prior to a final step of the live update processing, the hypervisor can look into the vPMEM (and optionally the supplemental storage if used) for cached data and mirror the cache data into the update virtual machine for use by the update virtual machine. This is conceptually depicted in FIG. 4D, in which the hypervisor 460 mirrors 490 cache data in vPMEM 416 to update virtual machine 420 as cached data 474. The hdisks 470, 472 of update virtual machine 420 can be rootvg(s) of the virtual machine 420 and/or other disks of the virtual machine.

Referring back to FIG. 3, the workflow mirrors (322) the cache data from the vPMEM (and optionally the supplemental storage if used) to the update virtual machine. At this point, the workflow can free up/delete (324) the cache data from the vPMEM and the workflow ends in a successful live update.

Based on completion of the live update processing, the update virtual machine takes over processing of the running workload and the update virtual machine includes (has) the mirrored cache data. In some examples, the update virtual machine subsequently uses some or all of the cache data that has been preserved, thereby improving performance and efficiency of the host system, including execution of the update virtual machine and processing the running workload.

In specific examples, the host system is part of a hybrid cloud environment that leverages models and tools such as an enterprise manager and installer that facilitate non-disruptive updates to virtual machines, including, for example, operating system kernels. In an example live update, the virtual machine can undergo a checkpoint process in which the workload is paused, and its current state is saved. Once the checkpoint is complete, the processes are migrated to the update virtual machine.

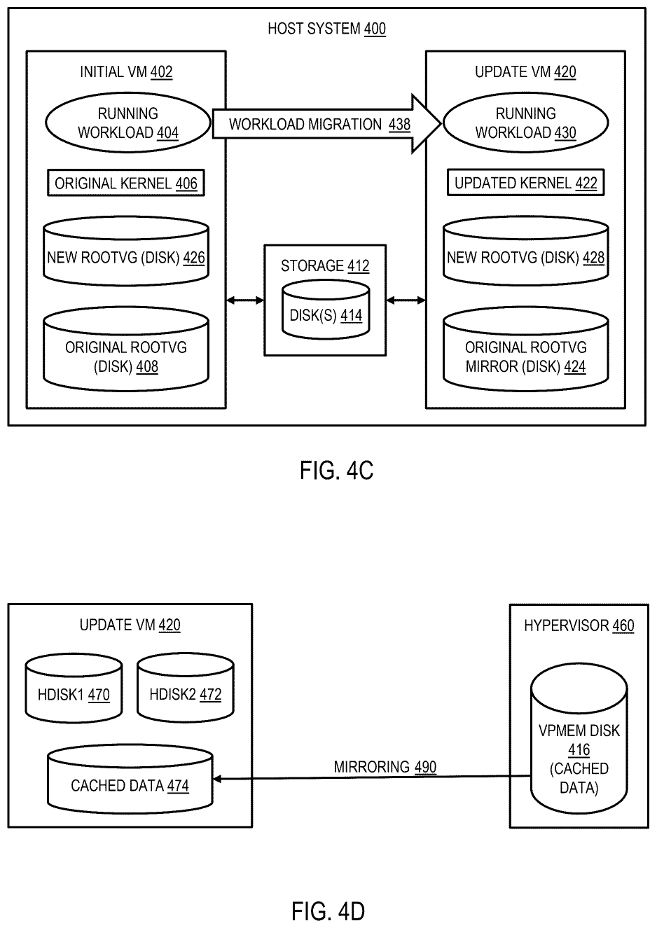

FIG. 5 depicts further details of example cache data preserving code (e.g., cache data preserving code 150 of FIG. 1) to incorporate and/or use aspects described herein. In one or more aspects, cache data preserving code 150 includes, in one example, various sub-modules to be used to perform preserving of cache data. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 (e.g., processor 200) and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 5, cache data preserving code 150 includes cache data identifying code 502 to identifying cache data of the initial virtual machine, cache data mirroring code 504 to mirror the cache data to persistent memory, and cache data mirroring code 506 to mirror the cache data from the persistent memory to the update virtual machine.

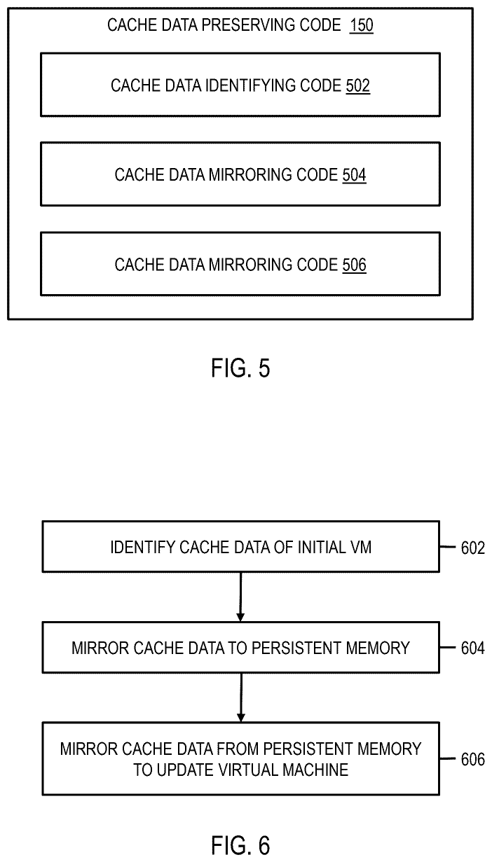

FIG. 6 depicts an example process for preserving cache data, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 6 are part of a module, such as code module 150. In other examples, the code may be included in one or more code modules and/or in one or more code sub-modules of the one or more modules. Various options are available. In some examples, the process of FIG. 6 is performed by a hypervisor of a host system, and optionally the hypervisor also performs the live update processing.

The process of FIG. 6 includes identifying (602), as setup for migrating a running workload from an initial virtual machine executing on a host system to an update virtual machine executing on the host system as part of a live update, cache data of the initial virtual machine. At least some of the cache data may be used in processing the running workload. The process also includes mirroring (604) the cache data to persistent memory. In examples, the persistent memory includes virtual persistent memory, and in further examples, the virtual persistent memory is backed by dynamic random access memory.

In some embodiments, mirroring the cache data to the persistent memory includes dynamically assigning the virtual persistent memory to the initial virtual machine based on identifying the cache data, and then mirroring at least some of the cache data to the virtual persistent memory. It may be the case, for example, that not all of the cache data is placed into the virtual persistent memory. For example, the persistent memory could further include supplemental storage to supplement the dynamically assigned virtual persistent memory, and the mirroring at least some of the cache data to the virtual persistent memory could mirror a portion of the cache data to the virtual persistent memory, where that portion consumes the virtual persistent memory assigned to the initial virtual machine. In these situations, mirroring the cache data to the persistent memory (604) can further include mirroring a remaining portion of the cache data to the supplemental storage.

In some examples, mirroring the cache data to the persistent memory prioritizes mirroring some cache data, such as more frequently used cache data or cache data that is comparatively warmer than other cache data, to the virtual persistent memory, and less frequently used cache data of cache data that is comparatively colder than the warmer cache data, to the supplemental storage.

Continuing with FIG. 6, based on performance of live update processing, which processing includes creating the update virtual machine and providing the update virtual machine with an operating system updated relative to an operating system of the initial virtual machine, the process includes mirroring (606) the cache data from the persistent memory to the update virtual machine. Based on completion of the live update processing, and the cache data having been migrated to the update virtual machine, the update virtual machine takes over processing of the running workload and it includes the mirrored cache data, which can then be used by the update virtual in processing the workload or any other processing.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method including:
identifying, as setup for migrating a running workload from an initial virtual machine executing on a host system to an update virtual machine executing on the host system as part of a live update, cache data of the initial virtual machine, wherein at least some of the cache data is used in processing the running workload;
mirroring the cache data to persistent memory; and
based on performance of live update processing that includes creating the update virtual machine and providing the update virtual machine with an operating system updated relative to an operating system of the initial virtual machine, mirroring the cache data from the persistent memory to the update virtual machine;
wherein based on completion of the live update processing, the update virtual machine takes over processing of the running workload and includes the mirrored cache data.

2. The method of claim 1, wherein the persistent memory includes virtual persistent memory.

3. The method of claim 2, wherein the virtual persistent memory is backed by dynamic random access memory.

4. The method of claim 2, wherein the mirroring the cache data to the persistent memory includes:
dynamically assigning the virtual persistent memory to the initial virtual machine based on identifying the cache data; and
mirroring at least some of the cache data to the virtual persistent memory.

5. The method of claim 4, wherein the persistent memory further includes supplemental storage to supplement the dynamically assigned virtual persistent memory, wherein the mirroring at least some of the cache data to the virtual persistent memory mirrors a portion of the cache data to the virtual persistent memory, wherein the portion consumes the virtual persistent memory assigned to the initial virtual machine, and wherein the mirroring the cache data to the persistent memory further includes mirroring a remaining portion of the cache data to the supplemental storage.

6. The method of claim 5, wherein the mirroring the cache data to the persistent memory prioritizes mirroring more frequently used cache data to the virtual persistent memory and less frequently used cache data to the supplemental storage.

7. The method of claim 1, wherein the identifying, the mirroring the cache data to the persistent memory, and the mirroring the cache data from the persistent memory are performed by a hypervisor of the host system, wherein the hypervisor also performs the live update processing.

8. A computer system comprising:
at least one computing device;
a set of one or more computer readable storage media; and
program instructions, collectively stored in the set of one or more computer readable storage media, for causing the at least one computing device to perform computer operations including:
identifying, as setup for migrating a running workload from an initial virtual machine executing on a host system to an update virtual machine executing on the host system as part of a live update, cache data of the initial virtual machine, wherein at least some of the cache data is used in processing the running workload;
mirroring the cache data to persistent memory; and
based on performance of live update processing that includes creating the update virtual machine and providing the update virtual machine with an operating system updated relative to an operating system of the initial virtual machine, mirroring the cache data from the persistent memory to the update virtual machine;
wherein based on completion of the live update processing, the update virtual machine takes over processing of the running workload and includes the mirrored cache data.

9. The computer system of claim 8, wherein the persistent memory includes virtual persistent memory.

10. The computer system of claim 9, wherein the virtual persistent memory is backed by dynamic random access memory.

11. The computer system of claim 9, wherein the mirroring the cache data to the persistent memory includes:
dynamically assigning the virtual persistent memory to the initial virtual machine based on identifying the cache data; and
mirroring at least some of the cache data to the virtual persistent memory.

12. The computer system of claim 11, wherein the persistent memory further includes supplemental storage to supplement the dynamically assigned virtual persistent memory, wherein the mirroring at least some of the cache data to the virtual persistent memory mirrors a portion of the cache data to the virtual persistent memory, wherein the portion consumes the virtual persistent memory assigned to the initial virtual machine, and wherein the mirroring the cache data to the persistent memory further includes mirroring a remaining portion of the cache data to the supplemental storage.

13. The computer system of claim 12, wherein the mirroring the cache data to the persistent memory prioritizes mirroring more frequently used cache data to the virtual persistent memory and less frequently used cache data to the supplemental storage.

14. The computer system of claim 8, wherein the identifying, the mirroring the cache data to the persistent memory, and the mirroring the cache data from the persistent memory are performed by a hypervisor of the host system, wherein the hypervisor also performs the live update processing.

15. A computer program product comprising:
a set of one or more computer readable storage media; and
program instructions, collectively stored in the set of one or more computer readable storage media, for causing at least one computing device to perform computer operations including:
identifying, as setup for migrating a running workload from an initial virtual machine executing on a host system to an update virtual machine executing on the host system as part of a live update, cache data of the initial virtual machine, wherein at least some of the cache data is used in processing the running workload;
mirroring the cache data to persistent memory; and
based on performance of live update processing that includes creating the update virtual machine and providing the update virtual machine with an operating system updated relative to an operating system of the initial virtual machine, mirroring the cache data from the persistent memory to the update virtual machine;
wherein based on completion of the live update processing, the update virtual machine takes over processing of the running workload and includes the mirrored cache data.

16. The computer program product of claim 15, wherein the persistent memory includes virtual persistent memory.

17. The computer program product of claim 16, wherein the virtual persistent memory is backed by dynamic random access memory.

18. The computer program product of claim 16, wherein the mirroring the cache data to the persistent memory includes:
dynamically assigning the virtual persistent memory to the initial virtual machine based on identifying the cache data; and
mirroring at least some of the cache data to the virtual persistent memory.

19. The computer program product of claim 18, wherein the persistent memory further includes supplemental storage to supplement the dynamically assigned virtual persistent memory, wherein the mirroring at least some of the cache data to the virtual persistent memory mirrors a portion of the cache data to the virtual persistent memory, wherein the portion consumes the virtual persistent memory assigned to the initial virtual machine, and wherein the mirroring the cache data to the persistent memory further includes mirroring a remaining portion of the cache data to the supplemental storage.

20. The computer program product of claim 19, wherein the mirroring the cache data to the persistent memory prioritizes mirroring more frequently used cache data to the virtual persistent memory and less frequently used cache data to the supplemental storage.
